(19) United States
(12) Patent Application Publication
(10) Pub. No.: US 2020/0111159 A1
(43) Pub. Date: Apr. 9, 2020

(54) SYSTEMS AND METHODS FOR DISTRIBUTED LEDGER-BASED STOCK TRANSACTIONS

(71) Applicant: JPMORGAN CHASE BANK, N.A., New York, NY (US)

(72) Inventor: Ankur SAMBHAR, Thane West (IN)

(21) Appl. No.: 16/596,473

(22) Filed: Oct. 8, 2019

Related U.S. Application Data
(60) Provisional application No. 62/742,661, filed on Oct. 8, 2018.

(51) Int. Cl. G06Q 40/04; G06Q 20/36

(52) U.S. Cl. CPC G06Q 40/04; G06Q 20/3678; G06Q 20/3672

(57) ABSTRACT

Systems and methods for distributed ledger-based stock transactions are disclosed. In one embodiment, in an information processing apparatus comprising at least one computer processor, a method for conducing distributed ledger-based stocked transactions may include: (1) receiving a stock purchase order for a stock comprising a purchase parameter; (2) identifying an available stock in a distributed ledger stock pool that meets the purchase parameter; (3) executing the stock purchase transaction by generating transaction data for the stock purchase order; (4) writing the transaction data to a distributed ledger; and (5) transferring a transaction amount from an electronic wallet for a buyer of the stock to an electronic wallet for a seller of the stock.

### RELATED APPLICATIONS

This application claims the benefit of U.S. Provisional Patent Application Ser. No. 62/742,661, filed Oct. 8, 2018, the disclosure of which is hereby incorporated by reference in its entirety.

### BACKGROUND OF THE INVENTION

### 1. Field of the Invention

Embodiments relate generally to stock transactions, and more particularly to systems and methods for distributed ledger-based stock transactions.

### 2. Description of the Related Art

Currently, transactions related to public listed instruments are executed over stock exchanges, such as the New York Stock Exchange or NASDAQ. The stock exchange ensures that the stocks and cash change hands and the actual custody of the stock changes to the buy-side user once the payment is made. Because this process requires the custody of the stock to be changed using trusted intermediaries, significant transaction fees are incurred. In addition, the settlement process, in which ownership is transferred to the buyer and the purchase amount is transferred to the seller, is a somewhat lengthy process which may take 1-3 days based on the particular stock exchange involved. Accordingly, while the current process executed on the traditional stock exchanges is effective, there are ample opportunities for improvement by reducing settlement times and transaction fees.

### SUMMARY OF THE INVENTION

Systems and methods for distributed ledger-based stock transactions are disclosed. According to one embodiment, a computer implemented method for conducting distributed ledger-based stock transactions may include: (1) storing data that defines a pool of stocks that are available for trading on a distributed ledger; (2) providing a user interface to enable a user to input a plurality of parameters related to a desired stock trade, wherein the parameters include a stock identifier and at least one of: a maximum purchase price, a minimum sales price, a number of shares, a designation of whether the transaction is a distributed ledger only transaction, a designation of whether a stock exchange transaction is permitted, and a maximum duration for the transaction; (3) receiving input from the user for the stock identifier and at least one of the plurality of parameters; (4) determining whether stock is available within the stock pool to satisfy the plurality of parameters related to the stock trade input by the user; (5) generating transaction data for the stock trade if the stock is available within the stock pool, wherein the transaction data includes the stock identifier, a number of shares, a buyer, a seller, a time of sale, and a sale price; (6) including the transaction data for the stock trade within a block; (7) adding the block to the distributed ledger by distributing the block to a plurality of nodes on the distributed ledger; and (8) transferring the purchase price of the stock to a seller of the stock.

According to another embodiment, in an information processing apparatus comprising at least one computer processor, a method for conducing distributed ledger-based stocked transactions may include: (1) receiving a stock purchase order for a stock comprising a purchase parameter; (2) identifying an available stock in a distributed ledger stock pool that meets the purchase parameter; (3) executing the stock purchase transaction by generating transaction data for the stock purchase order; (4) writing the transaction data to a distributed ledger; and (5) transferring a transaction amount from an electronic wallet for a buyer of the stock to an electronic wallet for a seller of the stock.

In one embodiment, the purchase parameter may include a stock identifier, a maximum purchase price, a number of shares to buy, a maximum duration to wait for a match on the distributed ledger system before executing the trade using an existing trade system, etc.

In one embodiment, the transaction data may include a stock identifier, a number of shares purchased, an identification of the buyer, an identification of the seller, a date and time of the transaction, the transaction amount, etc.

In one embodiment, the transaction amount may be based on a stock exchange market price for the stock, may be based on matching the maximum purchase price with a minimum sales price identified by the seller, etc.

In one embodiment, the electronic wallet for the buyer of the stock and the electronic wallet for the seller of the stock may be maintained on the distributed ledger.

According to another embodiment, in an information processing apparatus comprising at least one computer processor, a method for conducing distributed ledger-based stocked transactions may include: (1) receiving a stock purchase order for a stock comprising a purchase parameter; (2) determining that a stock that meets the purchase parameter is not available in a distributed ledger stock pool; (3) executing a first stock purchase transaction for the stock with a stock exchange based on the purchase parameter; (4) adding the stock to the distributed ledger stock pool; (5) executing a second stock purchase transaction by generating transaction data for the stock purchase order; (6) writing the transaction data to a distributed ledger; and (7) transferring a transaction amount from an electronic wallet for a buyer of the stock to an electronic wallet for a seller of the stock.

In one embodiment, the purchase parameter may include a stock identifier, a maximum purchase price, and a number of shares to buy, etc.

In one embodiment, the transaction data may include a stock identifier, a number of shares purchased, an identification of the buyer, an identification of the seller, a date and time of the transaction, the transaction amount, etc.

In one embodiment, the transaction amount may be based on a stock exchange market price for the stock.

In one embodiment, the electronic wallet for the buyer of the stock and the electronic wallet for the seller of the stock may be maintained on the distributed ledger.

According to another embodiment, in an information processing apparatus comprising at least one computer processor, a method for conducing distributed ledger-based stocked transactions may include: (1) receiving a stock sale order for a stock comprising a sale parameter from a seller; (2) identifying a purchase order for the stock from a buyer having a purchase parameter matching the sale parameter; (3) executing the stock purchase transaction by generating transaction data for the stock sale order; (4) writing the transaction data to a distributed ledger; and (5) transferring a transaction amount from an electronic wallet for the buyer of the stock to an electronic wallet for the seller of the stock.

In one embodiment, the sale parameter may include a stock identifier, a maximum sale price, a number of shares to sell, etc.

In one embodiment, the purchase parameter may include a stock identifier, a maximum purchase price, a number of shares to buy, etc.

In one embodiment, the transaction data may include a stock identifier, a number of shares sold, an identification of the buyer, an identification of the seller, a date and time of the transaction, the transaction amount, etc.

In one embodiment, the transaction amount may be based on a stock exchange market price for the stock, may be based on matching a maximum purchase price in the purchase parameter with a minimum sales price in the sale parameter, etc.

In one embodiment, the electronic wallet for the buyer of the stock and the electronic wallet for the seller of the stock may be maintained on the distributed ledger.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for providing distributed ledger-based stock transactions according to one embodiment; and

FIG. 2 depicts a method for conducting distributed ledger-based stock transactions according to one embodiment.

### DETAILED DESCRIPTION OF PREFERRED EMBODIMENTS

Embodiments are generally directed to systems and methods for distributed ledger-based stock transactions.

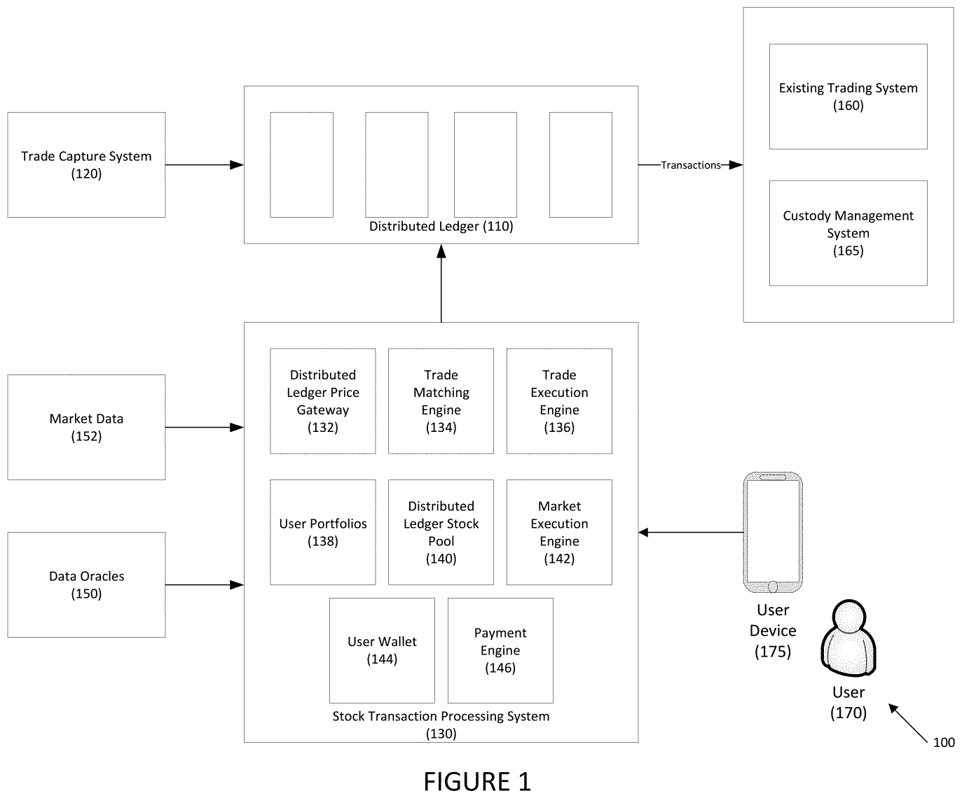

FIG. 1 illustrates a system architecture for a distributed ledger-based stock transaction system according to an exemplary embodiment of the invention. As shown in FIG. 1, system 100 may include distributed ledger 110, trade capture system 120, and stock transaction processing system 130.

Distributed ledger 110 may include any suitable immutable, cryptographically-verifiable distributed ledger system that includes a plurality of nodes, where each node includes one or more computer servers providing processing power and data storage. Distributed ledgers, such as Blockchain-based distributed ledgers, provide cryptographically-verified ledgers where trust is not provided by a central authority or trusted intermediary, but is instead established by the dissemination of identical copies of the same ledger with cryptographic proof of its correctness to each of the nodes.

Each event within a predefined set of events may be a “transaction” for which the data may be written as a new block, or part of a new block, in the distributed ledger, and each transaction creates a permanent record and allows each part of the stock transaction chain to be linked together.

Distributed ledger 110 may comprise a public, private, permissioned, or consortium-type distributed ledger. According to one embodiment, the distributed ledger 110 may include a permissioned Blockchain operated by a group of financial institutions, such as banks, FinTechs (e.g., financial technology services providers), etc., each of which operates at least one node on the distributed ledger, wherein each node comprises computer servers providing processing power, software, and data storage.

System 100 may also include trade capture system 120. Trade capture system 120 may include a software system that provides an interface, such as a graphical user interface (GUI), a command line interface (CLI), or an application programming interface (API), allowing user 170 to input parameters that define one or more desired stock transactions using, for example, a user device 175 (e.g., smartphone, smart watch, tablet computer, desktop computer, kiosk, Internet of Things (IoT) appliance, etc.). The parameters may include, for example, a stock identifier (e.g., IBM), a maximum purchase price, a minimum sale price, whether user 170 will permit only distributed ledger transactions or will also permit transactions on the stock exchange, and a maximum duration for executing the transaction. User 170 may also specify a hybrid combination such as allowing only distributed ledger transactions for a specified time period (e.g., 3 minutes) and thereafter permitting a transaction on the stock exchange.

In case of executing transactions only over the distributed ledger 110, it may take more time to find the match because distributed ledger stock pool 140 will generally be smaller than the stocks available on the stock exchange; however, the transaction fees on distributed ledger 110 will be significantly less than the transaction fees on the exchange.

After user 170 has input the relevant parameters for the transaction, trade capture system 120 may initiate the transaction on the distributed ledger 110 to record the trade on distributed ledger 110.

Stock transaction processing system 130 may be a system operated by a financial institution such as a bank, a FinTech, etc. Stock transaction processing system 130 may comprise one or more servers that include computer processors, electronic memory, and software to execute various functions available to the users. Stock transaction processing system 130 may include modules 132, 134, 136, 138, 140, 142, 144, 146, each of which may provide different functionalities for system 100.

Although modules 132, 134, 136, 138, 140, 142, 144, 146 are illustrated and described separately, it should be recognized that any of modules 132, 134, 136, 138, 140, 142, 144, 146 or the functionality provided by these modules may be combined as is necessary and/or desired.

Some of foregoing modules may include smart contracts comprising computer code or algorithms that are executed automatically upon the satisfaction of certain events to initiate and record a distributed ledger transaction. The modules including the smart contracts may be dependent on data from external sources to make a decision, execute a routine, or execute a distributed ledger transaction. This data will be provided to modules 132, 134, 136, 138, 140, 142, 144, 146 and smart contracts through data oracles 150. Data oracles 150 may include software agents that obtain and verify external events or data, and submit this information to the modules and smart contracts.

Stock transaction processing system 130 may include distributed ledger price gateway 132, which may be a module (e.g., software and/or hardware) that is configured to retrieve the current price of a desired stock from the relevant stock exchange or from market data 152 (e.g., a vendor such as Bloomberg, Reuters, etc.) and provide it for the distributed ledger transaction. Distributed ledger price gateway 132 may thus enable the stock trades to be executed on distributed ledger 110 at the same price or substantially the same price as that of the stock market.

Trade matching engine 134 may include a module including a smart contract that matches trades on distributed ledger 110 between the buy and the sell side. Trade matching engine 134 may compare the bid price and the ask price for a given stock in distributed ledger stock pool 140. Once it matches, trade matching engine 134 may pass the buy and sell side trade details (e.g., stock identifier, time of transaction, purchase price, buyer, seller) to trade execution engine 136.

Trade execution engine 136 may include a smart contract that may execute the trades and transfers the ownership of the stock on distributed ledger 110 by executing a distributed ledger transaction with the appropriate information on the ownership transfer (e.g., buyer, seller, purchase price, number of shares, time of transaction). Trade execution engine 136 may also record, as a distributed ledger transaction, additional information related to stock transactions, such as market pricing information for certain stocks, bid and ask prices, stock transfer agreement parameters (e.g., stock identifier, buyer, seller, time, number of shares, price), and settlement information including ownership transfer and cash payment details.

User portfolio module 138 may store the details of the stock portfolios associated with each user 170 of system 100 and may reflect the current state of one or more user's holdings. For example, user portfolio module 138 may update each user portfolio after each transaction.

Distributed ledger pool 140 may store a record of all the stocks that are available on distributed ledger 110 for the buy side and sell side (the “stock pool”). Distributed ledger stock pool 140 may be used by trade matching engine 134 to determine availability when a buy or sell transaction is initiated by user 170.

In one embodiment, the bank may create distributed ledger stock pool 140 by offering user 170 the option to register some or all of his or her stocks. User 170 may choose to register stocks when the user 170 executes a distributed ledger transaction on system 100, may also choose to register stocks in distributed ledger stock pool 140 beforehand, or whenever desired. For example, the bank may offer users 170 the ability to register all of the stocks in their portfolios with distributed ledger stock pool 140 before user 170 has conducted any transactions on the distributed ledger 110. In this way, the bank may more quickly assemble a large stock pool for transactions by users 170, which will be beneficial in terms of matching buyers to sellers on system 100.

The bank may also allow users 170 to register stocks in distributed ledger stock pool 140 without requiring a transfer in current ownership records maintained by the current custodian (e.g., the current broker or other custodian listed as the owner). According to one embodiment, for the existing stocks, user 170 may register stocks to the stock pool without moving the actual custody with the current custodian. The given stock may thus still be aligned to user 170 for the current custodian. For example, Bob owns 100 shares of IBM which are held with a third-party custodian ABC. The system allows Bob to register his 100 shares of IBM to distributed ledger stock pool 140, but will not require any changes to be made at ABC. The stocks will continue to be held with ABC in the name of Bob.

Market execution engine 142 may execute trades in the market outside system 100. For example, if user 170 wishes to purchase a stock that is not in the current distributed ledger stock pool 140, market execution engine 142 will purchase the stock from the applicable stock exchange and place the stock in distributed ledger stock pool 140. Market execution engine 144 may be configured to interface with the bank's existing trading platform 160, which executes the trade on the stock exchange.

After market execution engine 142 purchases the stock on the exchange, the stock may be registered in distributed ledger stock pool 140 and available for trading in system 100. Custody management system 165 may maintain records of stock ownership for trades executed on the stock exchanges with existing trading system 160. These trades may include trades executed in the typical manner (i.e., independent of the distributed ledger system), as well as trades initiated by market execution engine 142. Trades initiated by market execution engine 142 may also have their stocks are also available in distributed ledger stock pool 140.

User wallet 144 may include wallet information associated with each user and may be used for transferring the funds for stock transactions. Based on the transaction, payment engine 146 may transfer the funds used to purchase the stock to the respective user wallet 144.

In one embodiment, user wallet 144 may be maintained on distributed ledger 110, a side ledger (not shown), etc.

The bank may provide an option for user 170 to select a distributed ledger transaction, or to allow transactions over the stock exchanges. User 170 may choose the option using, for example, trade capture system 120. In general, a distributed ledger-only transaction option will incur much lower fees because the distributed ledger system eliminates the need for trusted intermediaries, as in the traditional exchange-based system, which are paid as transaction fees. User 170 may elect to permit exchange transactions so that if there is no match within a certain specified time period, system 100 will execute the transaction on the stock exchange.

For distributed ledger transactions, user 170 may execute the stock transactions on distributed ledger 110 but will not transfer the actual custody of the stock. The bank or a third-party vendor (e.g., a broker) may maintain the record ownership of the stocks. If desired, user 170 can opt to transfer the custody to his or her name, which will incur the clearing house fee for user 170 and will go through the existing traditional clearing and settlement flow.

System 100 will allow users 170 to save transaction fees incurred in traditional stock transactions executed on the stock exchanges. For the transactions executed on distributed ledger 110, the balance and current ownership of the stocks will be transparent to anyone with access to distributed ledger 110.

The bank will maintain the distributed ledger stock pool 140 on distributed ledger 110 along with the ownership of the stocks by each user 170. For any transaction, the bank will check if the stock is available for purchase or sale on distributed ledger 110 itself. If yes, then the bank will create a transaction on the blockchain with the ownership and pricing information, e.g., buyer, seller, date and time of transaction, the price per share, the number of shares, etc. System 100 will allow the bank to change the ownership of the stocks on distributed ledger 110 to enable the bank to identify who owns how much stock from distributed ledger stock pool 140.

From the perspective of the stock exchange, the bank will generally have custody of all the stocks in distributed ledger stock pool 140. However, user 170 may opt to have a third-party custodian maintain custody of his or her stocks and in that case the custodian will have the custody details of those stocks to the given user 170. Internally, the bank may maintain the ownership and transaction ledger on distributed ledger 110 to determine each user's portfolio along with ownership of each stock in distributed ledger stock pool 140.

Stocks will be changing hands over distributed ledger 110 itself while distributed ledger stock pool 140 remains untouched. If user 170 sells a stock, the proceeds from the sale will be made available to user 170 in user wallet 144 over distributed ledger 110. If user 170 wants to redeem cash, the bank will move the given amount from user wallet 144 to the user's bank account, which may be linked to user wallet 144 according to one embodiment of the invention.

System 100 may provide a significant reduction in transaction fees for user 170, as the stocks will not be changing ownership over the stock exchange. From the custody perspective, mostly custody will not change for distributed ledger transactions. As the ownership will typically be changing only over distributed ledger 110, the settlement time will be greatly reduced, such as nearly instantaneous settlement, settlement within a few seconds or minutes. Due to lower transaction fees, the bank may attract many more customers.

In addition, because custody of the stocks will not be changing on the stock exchange, the transaction fees incurred in the stock exchange transaction will be avoided. The bank will maintain ownership of the stock from the perspective of the stock exchange but internally will maintain the ledger of the actual owners. The ownership history for the stocks in the blockchain stock pool will be accessible to the users 170 of system 100.

One example of a blockchain stock transaction would be as follows. Alice buys 1000 shares of IBM stock at $60 per share on the bank's blockchain 110. Distributed ledger 110 may be a permissioned blockchain that is also used by a number of other banks, for example. The bank purchases the IBM stock and maintains its custody. The bank will record this purchase of IBM stock, along with Alice's ownership details, as a blockchain transaction. After two weeks Alice sells her IBM stock to Bob for $70 per share. The bank updates the blockchain with Alice's digital wallet with an amount of $70,000. The bank will also update the blockchain to reflect Bob as the purchaser and owner of the 1000 shares of IBM stock for $70 per share. The bank does not need to execute any transaction over the stock exchange.

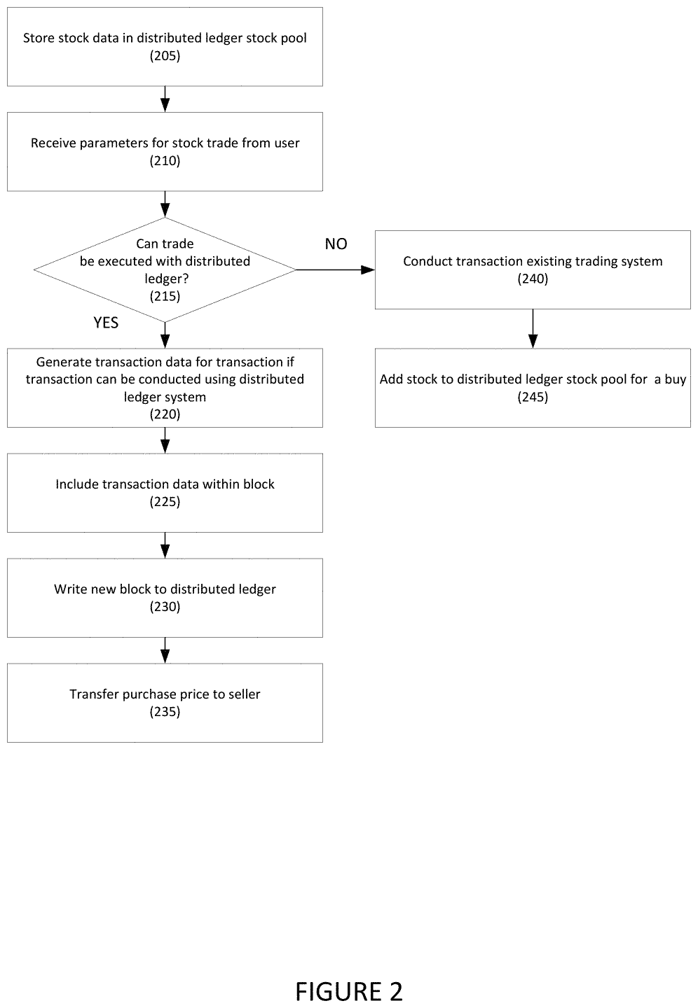

Referring now to FIG. 2, an exemplary method for distributed ledger-based stock transactions is disclosed according to one embodiment. In step 205, an entity (e.g., a financial institution, a FinTech, etc.) operating the distributed ledger stock exchange system stores data defining a pool of stocks that are available for trading on a distributed ledger. The data for each available stock may include, for example, a stock identifier, a stock owner, and a number of shares owned by the owner. The stock pool is defined by the collection of stocks available for trading on the distributed ledger.

In step 210, the system may receive, from a user and via a user interface, a plurality of parameters related to a desired stock trade. The stock trade may be for a purchase of a stock, or a sale of a stock. The parameters may include a stock identifier, a maximum purchase price, a minimum sales price, a number of shares to buy or sell, a designation of whether the transaction is a distributed ledger only transaction, a designation of whether a stock exchange transaction is permitted, and a maximum duration to wait for a match on the distributed ledger system before executing the trade using an existing trade system. Any other parameters may be received as is necessary and/or desired.

In step 215, the system may determine whether the trade can be matched with another trade on the distributed ledger system (e.g., matching a buy trade with a sell trade, and vice-versa). For example, for a buy, the system may check to see that the stock is available in the distributed ledger stock pool, that the parameters are met (e.g., the number of shares are available, pricing, etc.), etc. For a sell, the system may check to see that there is a buyer for the stock that meets the parameters (e.g., the number of shares are available, pricing, etc.), etc.

If the trade can be executed using the distributed ledger system, in step 220, the system may generate transaction data for the stock trade, wherein the transaction data includes the stock identifier, a number of shares, a buyer, a seller, the date and time of transaction, a transaction price, etc.

In one embodiment, the transaction price may be based on the market price for the stock, or it may be independent of the market price based on matching a desired purchase price with a desired sales price. For example, if the system finds the match on the distributed ledger, the transaction does not need to be aligned to the market price.

In step 225, the system may include the transaction data for the stock trade, as well as any other necessary information (e.g., buyer, seller, market data, etc.) within a block.

In step 230, the system may write the block to the distributed ledger by distributing the block to a plurality of nodes on the distributed ledger.

In step 235, the system may transfer the transaction price of the stock from the buyer to the seller using, for example, user electronic wallets. In one embodiment, the user electronic wallets may be maintained on the distributed ledger.

If, in step 215, the transaction cannot be conducted using the distributed ledger system because, for example, the stock is not available in the distributed ledger stock pool, there are insufficient shares available to meet the parameters, there is no buyer for the stock, etc., in step 240, the system may execute the transaction using, for example, an existing trading system. If the transaction is a buy, in step 245, the stock may be added to the distributed ledger stock pool.

In one embodiment, the transaction price may be transferred to the seller of the stock on the existing trading system. In another embodiment, the buyer may commit funds for the purchase by having funds transferred from the buyer's electronic wallet to a system electronic wallet, and then the system may pay the seller with these funds.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for conducing distributed ledger-based stocked transactions, comprising:
in an information processing apparatus comprising at least one computer processor:
receiving a stock purchase order for a stock comprising a purchase parameter;
identifying an available stock in a distributed ledger stock pool that meets the purchase parameter;
executing the stock purchase transaction by generating transaction data for the stock purchase order;
writing the transaction data to a distributed ledger; and
transferring a transaction amount from an electronic wallet for a buyer of the stock to an electronic wallet for a seller of the stock.

2. The method of claim 1, wherein the purchase parameter comprises at least one of a stock identifier, a maximum purchase price, and a number of shares to buy.

3. The method of claim 2, wherein the purchase parameter further comprises a maximum duration to wait for a match on the distributed ledger system before executing the trade using an existing trade system.

4. The method of claim 1, wherein the transaction data comprises a stock identifier, a number of shares purchased, an identification of the buyer, an identification of the seller, a date and time of the transaction, and the transaction amount.

5. The method of claim 1, wherein the transaction amount is based on a stock exchange market price for the stock.

6. The method of claim 1, wherein the transaction amount is based on matching the maximum purchase price with a minimum sales price identified by the seller.

7. The method of claim 1, wherein the electronic wallet for the buyer of the stock and the electronic wallet for the seller of the stock are maintained on the distributed ledger.

8. A method for conducing distributed ledger-based stocked transactions, comprising:
in an information processing apparatus comprising at least one computer processor:
receiving a stock purchase order for a stock comprising a purchase parameter;
determining that a stock that meets the purchase parameter is not available in a distributed ledger stock pool;
executing a first stock purchase transaction for the stock with a stock exchange based on the purchase parameter;
adding the stock to the distributed ledger stock pool;
executing a second stock purchase transaction by generating transaction data for the stock purchase order;
writing the transaction data to a distributed ledger; and
transferring a transaction amount from an electronic wallet for a buyer of the stock to an electronic wallet for a seller of the stock.

9. The method of claim 8, wherein the purchase parameter comprises at least one of a stock identifier, a maximum purchase price, and a number of shares to buy.

10. The method of claim 8, wherein the transaction data comprises a stock identifier, a number of shares purchased, an identification of the buyer, an identification of the seller, a date and time of the transaction, and the transaction amount.

11. The method of claim 8, wherein the transaction amount is based on a stock exchange market price for the stock.

12. The method of claim 8, wherein the electronic wallet for the buyer of the stock and the electronic wallet for the seller of the stock are maintained on the distributed ledger.

13. A method for conducing distributed ledger-based stocked transactions, comprising:
in an information processing apparatus comprising at least one computer processor:
receiving a stock sale order for a stock comprising a sale parameter from a seller;
identifying a purchase order for the stock from a buyer having a purchase parameter matching the sale parameter;
executing the stock purchase transaction by generating transaction data for the stock sale order;
writing the transaction data to a distributed ledger; and
transferring a transaction amount from an electronic wallet for the buyer of the stock to an electronic wallet for the seller of the stock.

14. The method of claim 13, wherein the sale parameter comprises at least one of a stock identifier, a maximum sale price, and a number of shares to sell.

15. The method of claim 13, wherein the purchase parameter comprises at least one of a stock identifier, a maximum purchase price, and a number of shares to buy.

16. The method of claim 13, wherein the transaction data comprises a stock identifier, a number of shares sold, an identification of the buyer, an identification of the seller, a date and time of the transaction, and the transaction amount.

17. The method of claim 13, wherein the transaction amount is based on a stock exchange market price for the stock.

18. The method of claim 13, wherein the transaction amount is based on matching a maximum purchase price in the purchase parameter with a minimum sales price in the sale parameter.

19. The method of claim 1, wherein the electronic wallet for the buyer of the stock and the electronic wallet for the seller of the stock are maintained on the distributed ledger.
